(19) United States
(12) Patent Application Publication
(10) Pub. No.: US 2025/0183529 A1
(43) Pub. Date: Jun. 5, 2025

(54) ANTENNA APPARATUS AND COMMUNICATION DEVICE

(71) Applicant: HUAWEI TECHNOLOGIES CO., LTD., Shenzhen (CN)

(72) Inventors: Xue BAI, Dongguan (CN); Weihong XIAO, Dongguan (CN)

(21) Appl. No.: 19/044,726

(22) Filed: Feb. 4, 2025

Related U.S. Application Data
(63) Continuation of application No. PCT/CN2023/103442, filed on Jun. 28, 2023.

(30) Foreign Application Priority Data
Aug. 5, 2022 (CN) 202210938915.1

(51) Int. Cl. H01Q 3/30; H01Q 1/12; H01Q 21/06

(52) U.S. Cl. CPC H01Q 3/30; H01Q 1/12; H01Q 21/06

(57) ABSTRACT

This application discloses an antenna apparatus and a communication device. The antenna apparatus includes an antenna array, a first drive mechanism, and a first phase shifter. The antenna array may include a plurality of radiating elements arranged in an array, and the plurality of radiating elements may be configured to radiate and receive an electromagnetic wave signal. The first drive mechanism is connected to the first phase shifter, and the first drive mechanism may control movement of the first phase shifter. The first phase shifter may be disposed above the antenna array. When an electromagnetic wave radiated by the antenna array passes through the first phase shifter, the first phase shifter may control a phase of the electromagnetic wave radiated by the antenna array, so that a beam of the antenna array is deflected.

### CROSS-REFERENCE TO RELATED APPLICATIONS

This application is a continuation of International Application No. PCT/CN2023/103442, filed on Jun. 28, 2023, which claims priority to Chinese Patent Application No. 202210938915.1, filed on August 2022. The disclosures of the aforementioned applications are hereby incorporated by reference in their entireties.

### TECHNICAL FIELD

This application relates to the field of communication technologies, and in particular, to an antenna apparatus in a base station system and a communication device.

### BACKGROUND

A phase shifter is a core component of a base station antenna. The phase shifter can adjust a phase and amplitude. In this way, the phase shifter plays a role in adjusting a pointing direction of a radiation pattern formed in space by the base station antenna, to meet a requirement of flexibly adjusting coverage of different user areas. Therefore, design quality of the phase shifter not only affects indicators such as a gain and the pattern of the base station antenna, but also affects a size and costs of the base station antenna. However, beam sweeping of an existing base station antenna on a vertical plane or a horizontal plane is insufficient, which causes a problem of insufficient base station signal coverage.

### SUMMARY

Embodiments of this application provide an antenna apparatus and a communication device. According to embodiments of this application, a beam sweeping range of a base station antenna on a vertical plane or a horizontal plane can be expanded, and signal coverage can be improved.

According to a first aspect, an embodiment of this application provides an antenna apparatus. The antenna apparatus may include an antenna array, a drive mechanism, and a first phase shifter. The antenna array may include a plurality of radiating elements arranged in an array, and the plurality of radiating elements may be configured to radiate and receive an electromagnetic wave signal. The first drive mechanism may be connected to the first phase shifter, and the first drive mechanism may control movement of the first phase shifter. The first phase shifter is disposed above the antenna array. When an electromagnetic wave radiated by the antenna array passes through the first phase shifter, the first phase shifter may control a phase of the electromagnetic wave radiated by the antenna array, so that a beam of the antenna array is deflected.

According to this embodiment of this application, the first phase shifter is disposed above the antenna array, and the first phase shifter can be moved under control of the drive mechanism. In this way, the beam of the antenna array can be adjusted and controlled, a beam sweeping range of a base station antenna on a vertical plane or a horizontal plane can be expanded, and signal coverage can be improved.

In an optional implementation, the antenna apparatus further includes a first radome. Both the first phase shifter and the antenna array may be disposed in the first radome; or the antenna array may be disposed in the first radome, and the first phase shifter is disposed in a second radome of another antenna apparatus.

In an optional implementation, the first phase shifter may include a plurality of phase shift blocks, and the plurality of phase shift blocks may cover a part of an aperture area of the antenna array. In this way, the beam of the antenna array can be adjusted and controlled, a good economic effect is achieved, and costs are reduced.

In an optional implementation, the first phase shifter includes a plurality of phase shift blocks, and the plurality of phase shift blocks may cover an entire aperture area of the antenna array. In this way, the beam sweeping range of the base station antenna on the vertical plane or the horizontal plane can be expanded, and the signal coverage can be improved.

In an optional implementation, the antenna apparatus further includes a first guide rail, the first phase shifter may include a plurality of first phase shift blocks located above the antenna array, the plurality of first phase shift blocks may all be located on a first horizontal plane, and the first drive mechanism may control the plurality of first phase shift blocks to slide on the first guide rail. Based on such a design, the first phase shifter may implement different physical states based on control of the first drive mechanism, so that a beam of the antenna apparatus can dynamically change.

In an optional implementation, the antenna apparatus may further include a second guide rail, the first phase shifter may further include a plurality of second phase shift blocks located above the antenna array, the plurality of second phase shift blocks may all be located on a second horizontal plane, and the first drive mechanism may control the plurality of second phase shift blocks to slide on the second guide rail. Based on such a design, the first phase shifter may implement different physical states based on control of the first drive mechanism, so that the beam of the antenna apparatus can dynamically change.

In an optional implementation, the first phase shifter may include a plurality of phase shift structures, each phase shift structure may include a first phase shift block and a second phase shift block that are located above the antenna array, and the first drive mechanism may control a spacing between the first phase shift block and the second phase shift block. Based on such a design, the first phase shifter may implement different physical states based on control of the first drive mechanism, so that a beam of the antenna apparatus can dynamically change.

In an optional implementation, the antenna apparatus may further include a second phase shifter. The second phase shifter is connected to the radiating element, and the second phase shifter may adjust a feeding phase of the radiating element. The antenna apparatus may further include a second drive mechanism, and the second drive mechanism may control movement of the second phase shifter. In this way, feeding phases of different antenna ports can be changed, to implement different radiation beam directions.

In an optional implementation, the antenna array may further include a reflection panel, the antenna array may be disposed on an upper surface of the reflection panel, and the second phase shifter may be disposed on a lower surface of the reflection panel.

According to a second aspect, an embodiment of this application provides a communication device. The communication device includes the antenna apparatus described above.

According to the antenna apparatus and the communication device provided in embodiments of this application, a component of a spatial phase shifter may be disposed above a radiation aperture of the antenna array. In this design, the beam sweeping range of the base station antenna on the vertical plane or the horizontal plane can be expanded, and the signal coverage can be improved.

### BRIEF DESCRIPTION OF DRAWINGS

FIG. 1 is a diagram of an application environment of an antenna apparatus according to an embodiment of this application;

FIG. 2 is a diagram of a structure of an antenna apparatus according to an embodiment of this application;

FIG. 3 is a diagram of another structure of an antenna apparatus according to an embodiment of this application;

FIG. 4 is a diagram of another structure of an antenna apparatus according to an embodiment of this application;

FIG. 5 is a diagram of another structure of an antenna apparatus according to an embodiment of this application;

FIG. 6 is a diagram of another structure of an antenna apparatus according to an embodiment of this application;

FIG. 7 is a diagram of another structure of an antenna apparatus according to an embodiment of this application;

FIG. 8 is a diagram of another structure of an antenna apparatus according to an embodiment of this application;

FIG. 9 is a diagram of another structure of an antenna apparatus according to an embodiment of this application;

FIG. 10 is a diagram of a structure of a first phase shifter according to an embodiment of this application;

FIG. 11 is a diagram of another structure of a first phase shifter according to an embodiment of this application;

FIG. 12 is a diagram of another structure of a first phase shifter according to an embodiment of this application;

FIG. 13 is a diagram of a state of the first phase shifter shown in FIG. 12;

FIG. 14 is a diagram of a structure of a first phase shifter according to an embodiment of this application;

FIG. 15 is a diagram of a state of the first phase shifter shown in FIG. 14;

FIG. 16 is a diagram of another state of the first phase shifter shown in FIG. 14;

FIG. 17 is a diagram of another structure of a first phase shifter according to an embodiment of this application;

FIG. 18 is a diagram of another structure of a first phase shifter according to an embodiment of this application;

FIG. 19 is a diagram of another structure of a first phase shifter according to an embodiment of this application;

FIG. 20 is a diagram of another structure of a first phase shifter according to an embodiment of this application;

FIG. 21 is a diagram of a structure of a phase shift block according to an embodiment of this application; and

FIG. 22 is a diagram of a structure of a communication device according to an embodiment of this application.

### DESCRIPTION OF EMBODIMENTS

To make the objectives, technical solutions, and advantages of embodiments of this application clearer, the following clearly and describes the technical solutions in embodiments of this application with reference to the accompanying drawings in embodiments of this application. It is clear that the described embodiments are only a part rather than all of embodiments of this application. All other embodiments obtained by a person of ordinary skill in the art based on embodiments of this application without creative efforts shall fall within the protection scope of this application.

It should be noted that when an element is considered to be “connected to” another element, the element may be directly connected to the another element, or there may be an element disposed between them. When an element is considered to be “disposed on” another element, the element may be directly disposed on the another element, or there may be an element disposed between them.

Unless otherwise defined, all technical and scientific terms used in this specification have same meanings as those usually understood by a person skilled in the art of this application. Terms used in this specification of this application are only intended to describe specific embodiments, but are not intended to limit this application. The term “and/or” used in this specification includes any and all combinations of one or more related listed items.

Embodiments of this application provide an antenna apparatus. A component of a spatial phase shifter is disposed above a radiation aperture of an antenna array. In this way, a problem of insufficient base station signal coverage caused by insufficient beam sweeping of a base station antenna on a vertical plane or a horizontal plane can be resolved.

To facilitate understanding of the antenna apparatus provided in embodiments of this application, the following first describes an application scenario of the antenna apparatus. The antenna apparatus provided in embodiments of this application may be used in a communication device such as a base station, and is used for the communication device to implement signal receiving and sending functions.

The following uses an example in which the antenna apparatus is used in a base station antenna feeder system for description.

FIG. 1 is a diagram of a scenario in which an antenna apparatus according to an embodiment of this application is used in a base station antenna feeder system.

In this embodiment, the base station antenna feeder system may include an antenna apparatus 100, an adjustment support 210, a pole 220, a connector sealing member 230, and a grounding apparatus 240.

One end of the antenna apparatus 100 may be mounted at a top position of the pole 220, and another end of the antenna apparatus 100 may be mounted at the top position of the pole 220 via the adjustment support 210. It may be understood that the adjustment support 210 may be configured to adjust an antenna downtilt. The antenna apparatus 100 may be connected to the grounding apparatus 240 via the connector sealing member 230. The connector sealing member 230 may be an insulation sealing tape or a PVC insulation tape. The grounding apparatus 240 may be for direct current grounding.

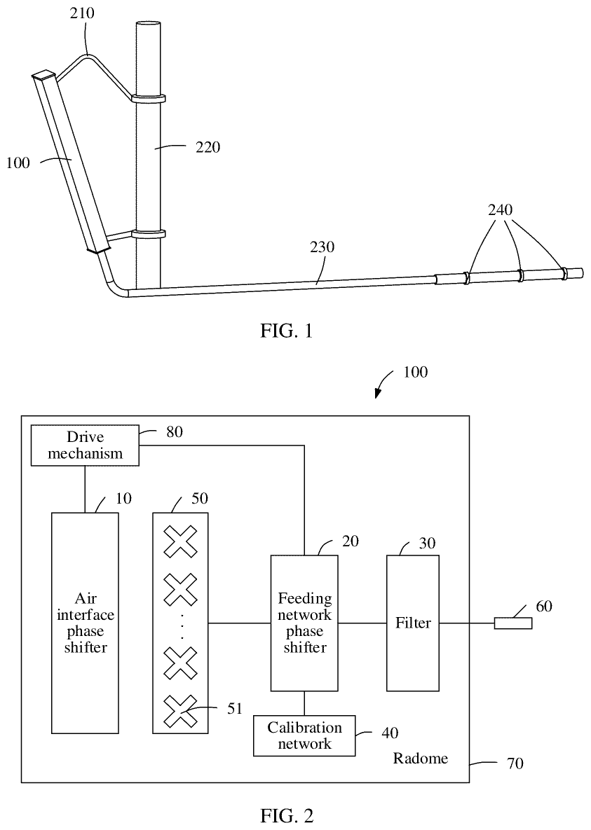

FIG. 2 is a diagram of a structure of an antenna apparatus 100 according to an embodiment of this application.

In this embodiment, the antenna apparatus 100 may include an air interface phase shifter 10, a feeding network phase shifter 20, a filter 30, a calibration network 40, and an antenna array 50. It may be understood that the air interface phase shifter 10 may be used as a first phase shifter in this embodiment of this application, and the feeding network phase shifter 20 may be used as a second phase shifter in this embodiment of this application.

The antenna array 50 may include a plurality of radiating elements 51 arranged in an array. The radiating element 51 is configured to radiate and receive an electromagnetic wave signal. The plurality of radiating elements 51 may be disposed on a reflection panel. The antenna array 50 may receive or transmit a radio frequency signal over a feeding network.

In this embodiment, the feeding network phase shifter 20 is connected to the antenna array 50. The feeding network phase shifter 20 may be configured to adjust feeding phases of the plurality of radiating elements 51. It may be understood that the feeding network phase shifter 20 may change feeding phases of different antenna ports, to implement different radiation beam directions.

The air interface phase shifter 10 may be connected to a drive mechanism 80, and the drive mechanism 80 may control mechanical movement of the air interface phase shifter 10.

In an optional implementation, the feeding network phase shifter 20 may be connected to the calibration network 40 to obtain a needed calibration signal. In this way, different radiation beam directions are implemented. In another optional implementation, the feeding network phase shifter 20 may alternatively be connected to the drive mechanism 80, and different radiation beam directions may be implemented via the drive mechanism 80. It may be understood that, in some optional implementations, the drive mechanism may adjust mechanical movement of the air interface phase shifter 10 in an electrical control manner.

In this embodiment, the filter 30 is connected between the phase shifter 20 and an antenna connector 60. It may be understood that a signal may be fed into the antenna apparatus 100 from the antenna connector 60. In another optional implementation, the feeding network phase shifter 20 may alternatively be connected to the antenna connector 60 via a combiner.

It may be understood that, in this embodiment, the air interface phase shifter 10 may be located above the antenna array 50. When an electromagnetic wave radiated by the antenna array 50 passes through the air interface phase shifter 10, a phase of the electromagnetic wave radiated by the antenna array 50 may be redistributed by the air interface phase shifter 10, so that an antenna beam is deflected.

The antenna apparatus 100 may further include a radome 70. In an optional implementation solution, the air interface phase shifter 10, the feeding network phase shifter 20, the filter 30, the calibration network 40, and the antenna array 50 may all be located in the radome 70. In other words, in the embodiment shown in FIG. 2, the air interface phase shifter 10 and the antenna array 50 may be located in the same radome 70.

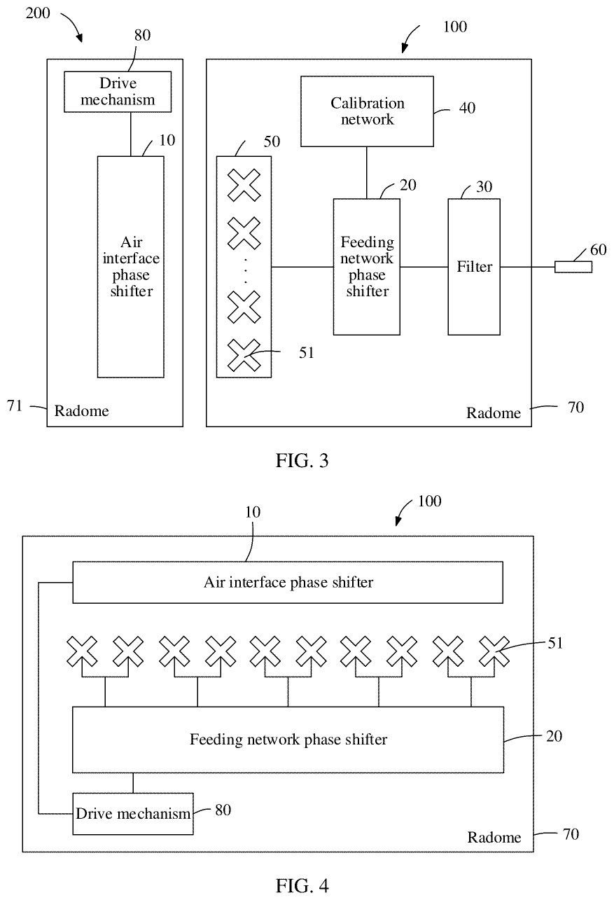

FIG. 3 is a diagram of a structure of an antenna apparatus 100 according to another embodiment of this application.

A difference from the antenna apparatus 100 shown in the embodiment in FIG. 2 lies in that, as shown in FIG. 3, a feeding network phase shifter 20, a filter 30, a calibration network 40, and an antenna array 50 in this embodiment may all be located in a radome 70, and an air interface phase shifter 10 may be located in a radome 71 of another antenna apparatus 200. In other words, in the embodiment shown in FIG. 3, the air interface phase shifter 10 may be located in a radome of another antenna apparatus different from the antenna array 50.

In this embodiment, the air interface phase shifter 10 may be connected to a drive mechanism 80. The drive mechanism 80 may control movement of the air interface phase shifter 10.

The feeding network phase shifter 20 may be connected to the calibration network 40 to obtain a needed calibration signal. In this way, different radiation beam directions are implemented. In some embodiments, the feeding network phase shifter 20 may alternatively be connected to the drive mechanism, and different radiation beam directions may be implemented via the drive mechanism.

FIG. 4 is a diagram of a structure of an antenna apparatus 100 according to another embodiment of this application. In this embodiment, the antenna apparatus 100 may include an air interface phase shifter 10, a feeding network phase shifter 20, an antenna array 50, and a drive mechanism 80. The antenna array 50 may include a plurality of radiating elements 51 arranged in an array.

In this embodiment, the drive mechanism 80 may be connected to the feeding network phase shifter 20 and the air interface phase shifter 10. The feeding network phase shifter 20 may be connected to the plurality of radiating elements 51. The plurality of radiating elements 51 may be disposed on a reflection panel. It may be understood that the air interface phase shifter 10, the feeding network phase shifter 20, the plurality of radiating elements 51, and the drive mechanism 80 may all be disposed in a radome 70.

In this embodiment, the drive mechanism 80 may be configured to control mechanical movement of the air interface phase shifter 10 and the feeding network phase shifter 20.

In this embodiment, the antenna apparatus 100 may control mechanical movement of the air interface phase shifter 10 via the drive mechanism 80, to implement different states, so that an antenna beam dynamically changes.

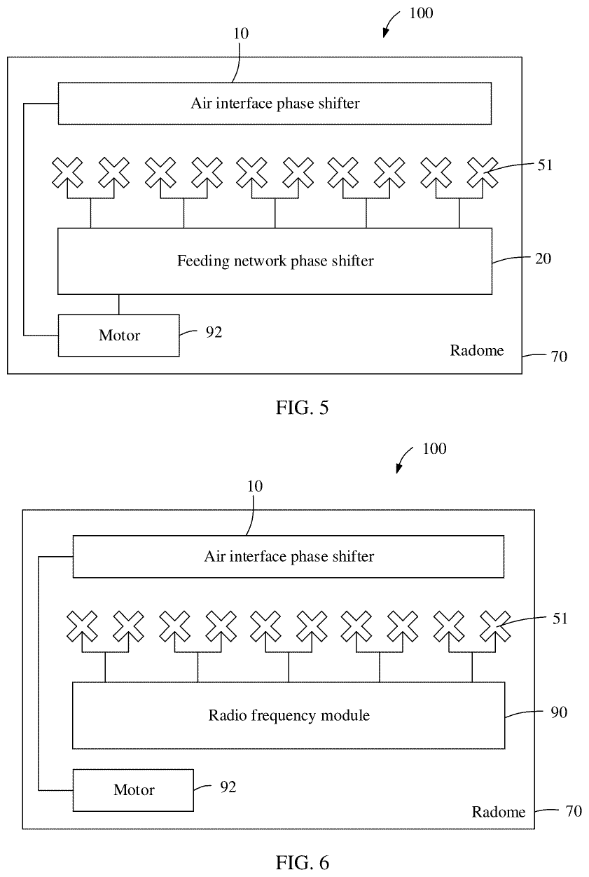

FIG. 5 is a diagram of a structure of an antenna apparatus 100 according to another embodiment of this application.

A difference from the antenna apparatus 100 shown in the embodiment in FIG. 4 lies in that, in this embodiment, as shown in FIG. 5, a drive mechanism 80 may include a motor 92. In other words, the motor 92 may be one of components of the drive mechanism 80.

The antenna apparatus 100 may control movement of an air interface phase shifter 10 and a feeding network phase shifter 20 via the motor 92. Specifically, the antenna apparatus 100 may control movement of the air interface phase shifter 10 via the motor 92, to implement different states, so that an antenna beam dynamically changes.

For example, electromagnetic wave signals may be fed into the plurality of radiating elements 51 via the feeding network phase shifter 20. The motor 92 may control amplitude and phases of the electromagnetic wave signals fed into the radiating elements 51. In this way, the antenna array radiates and propagates an electromagnetic wave to the air in a specific direction. In this embodiment, the air interface phase shifter 10 may be located above the antenna array 50.

Therefore, after electromagnetic waves radiated by the radiating elements 51 pass through the air interface phase shifter 10, phases of the electromagnetic waves radiated by the radiating elements 51 may be redistributed by the air interface phase shifter 10, so that the antenna beam is deflected. According to the antenna apparatus in this embodiment of this application, a beam sweeping range of the base station antenna on a vertical plane or a horizontal plane is larger, and more beams can be selected.

FIG. 6 is a diagram of a structure of an antenna apparatus 100 according to another embodiment of this application.

A difference from the antenna apparatus 100 shown in the embodiment in FIG. 5 lies in that, as shown in FIG. 6, the antenna apparatus 100 in this embodiment may not include a feeding network phase shifter 20.

In this embodiment, a plurality of radiating elements 51 may be connected to a radio frequency module 90. The radio frequency module 90 may be configured to feed a signal into the antenna array 50.

A motor 92 may be connected to an air interface phase shifter 10. The air interface phase shifter 10 may be located above the plurality of radiating elements 51. It may be understood that, the antenna apparatus 100 in this embodiment may control mechanical movement of the air interface phase shifter 10 via the motor 92, to implement different states, so that an antenna beam can dynamically change.

According to the embodiment shown in FIG. 6, the antenna apparatus can expand a beam sweeping range of the base station antenna on a vertical plane or a horizontal plane, improve signal coverage, and improve use experience.

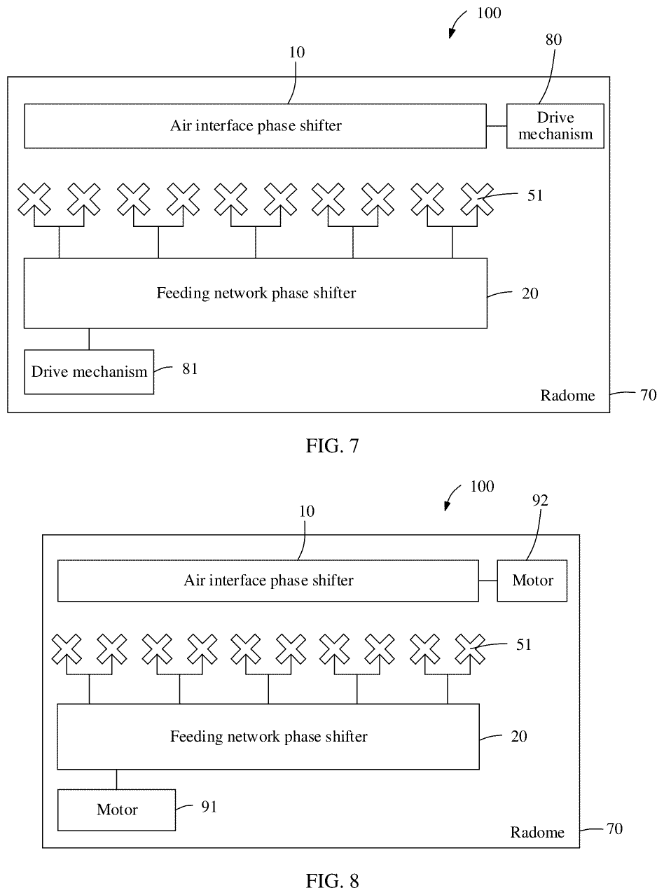

FIG. 7 is a diagram of a structure of an antenna apparatus 100 according to another embodiment of this application.

A difference from the antenna apparatus 100 shown in the embodiment in FIG. 4 lies in that, as shown in FIG. 7, the antenna apparatus 100 in this embodiment may further include a drive mechanism 81.

In this embodiment, a drive mechanism 80 is connected to an air interface phase shifter 10. The drive mechanism 81 is connected to a feeding network phase shifter 20, and the feeding network phase shifter 20 may be connected to a plurality of radiating elements 51.

The air interface phase shifter 10 is located above the plurality of radiating elements 51, and the drive mechanism 80 may be configured to control mechanical movement of the air interface phase shifter 10. The drive mechanism 81 may control mechanical movement of the feeding network phase shifter 20.

FIG. 8 is a diagram of a structure of an antenna apparatus 100 according to another embodiment of this application.

A difference from the antenna apparatus 100 shown in the embodiment in FIG. 7 lies in that, as shown in FIG. 8, a drive mechanism 80 in this embodiment may include a motor 92, and a drive mechanism 81 may a motor include 91. In other words, the motor 92 may be one of drive components of the drive mechanism 80. In some specific implementations, the drive mechanism 80 may further include a drive component such as a pull rod. The motor 91 may be one of drive components of the drive mechanism 81. In some specific implementations, the drive mechanism 81 may further include a drive component such as a pull rod.

As shown in FIG. 8, in this embodiment, the motor 92 is connected to an air interface phase shifter 10. The motor 91 is connected to a feeding network phase shifter 20, and the feeding network phase shifter 20 may be connected to a plurality of radiating elements 51.

It may be understood that the motor 92 may control mechanical movement of the air interface phase shifter 10. The motor 91 may control mechanical movement of the feeding network phase shifter 20. Based on such a design, the antenna apparatus 100 may control movement of the air interface phase shifter 10 via the motor 92, to implement different states, so that an antenna beam can dynamically change.

In this embodiment, the air interface phase shifter 10, the motor 92, the feeding network phase shifter 20, the motor 91, and the plurality of radiating elements 51 are all located in a radome 70.

The air interface phase shifter 10 in this embodiment may be controlled via the independent motor 92. In other words, a control motor of the air interface phase shifter 10 may be different from a control motor of the feeding network phase shifter 20. In this design, product configuration can be more flexible, and disassembly, replacement, and maintenance of the motor can be facilitated.

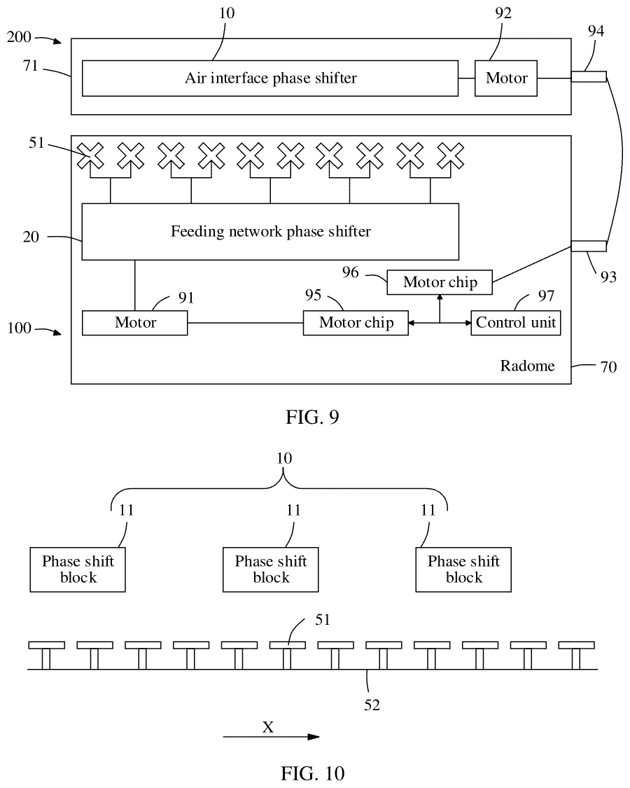

FIG. 9 is a diagram of a structure of an antenna apparatus 100 according to another embodiment of this application.

A difference from the antenna apparatus 100 shown in the embodiment in FIG. 8 lies in that, as shown in FIG. 9, a motor 92 and an air interface phase shifter 10 in this embodiment may be disposed in a radome 71 of another antenna apparatus 200. A motor 91, a feeding network phase shifter 20, and a plurality of radiating elements 51 are disposed in a radome 70. In other words, the air interface phase shifter 10 and the motor 91 may be located in the radome 71 of another antenna apparatus 200 different from the feeding network phase shifter 20 and the plurality of radiating elements 51.

In this embodiment, the antenna apparatus 200 may be located above an aperture surface of the antenna apparatus 100. The air interface phase shifter 10 may be connected to the motor 92, and the motor 92 may control mechanical movement of the air interface phase shifter 10. The air interface phase shifter 10 may be disposed above the plurality of radiating elements 51.

The antenna apparatus 100 further includes a motor interface 93. The motor interface 93 may be disposed outside the radome 70. The antenna apparatus 200 further includes a motor interface 94. The motor interface 94 may be disposed outside the radome 71. The motor interface 93 may be connected to the motor interface 94.

In an optional implementation, the antenna apparatus 100 may further include a motor chip 95 and a motor chip 96.

The motor chip 95 may be connected to the motor 91, and the motor 91 may be connected to the feeding network phase shifter 20, to control mechanical movement of the feeding network phase shifter 20. For example, the motor chip 95 may output a drive signal to the motor 91, so that the motor 91 can control mechanical movement of the feeding network phase shifter 20.

The motor interface 94 is connected to the motor 92, and the motor chip 96 may be connected to the motor interface 93. The motor interface 93 may be connected to the motor interface 94. Based on such a design, the motor chip 96 may establish a communication connection to the motor 92 through the motor interface 93 and the motor interface 94. For example, the motor chip 96 may output a drive signal to the motor 92 through the motor interface 93 and the motor interface 94. In this way, the motor 92 can control mechanical movement of the air interface phase shifter 10.

It may be understood that, in this embodiment, the motor chip 95, the motor chip 96, and the motor 91 may all be disposed in the radome 70 of the antenna apparatus 100. The motor 92 may be disposed in the radome 71 of the antenna apparatus 200.

In an optional implementation, the antenna apparatus 100 may further include a control unit 97. The control unit 97 may be a microcontroller unit (Microcontroller Unit, MCU). The control unit 97 may output control instructions to the motor chip 95 and the motor chip 96 to control the motor 91 and the motor 92.

In a specific implementation process, the control unit 97 may be communicatively connected to the motor chip 95 and the motor chip 96. For example, in some implementations, the control unit 97 may output a control instruction to the motor chip 95 through a communication bus, and the control unit 97 may further output a control instruction to the motor chip 96 through a communication bus.

According to the antenna apparatus shown in the embodiment in FIG. 9, in some embodiments of this application, the motor chip 96 in the antenna apparatus 100 may be used to control the motor 92 in the antenna apparatus 200, to control different states of the air interface phase shifter 10. According to this embodiment of this application, the two antenna apparatuses may share one control unit, and may share control instructions of one MCU. In this way, hardware resources can be saved, and costs can be reduced.

FIG. 10 is a diagram of a structure of an air interface phase shifter 10 according to an embodiment of this application. It may be understood that, in this embodiment of this application, the air interface phase shifter 10 may include a plurality of phase shift blocks 11.

As shown in FIG. 10, the plurality of phase shift blocks 11 may be disposed above a plurality of radiating elements 51. It may be understood that the plurality of phase shift blocks 11 may cover the plurality of radiating elements 51 in a first direction. The first direction may be an X direction shown in FIG. 10. In other words, the plurality of phase shift blocks 11 may be periodically distributed in longitudinal space in which an antenna beam needs to be deflected.

FIG. 10 shows only three phase shift blocks 11 as an example for description. In some embodiments, a quantity of the plurality of phase shift blocks 11 may be greater than or equal to two.

In this embodiment, as shown in FIG. 10, the plurality of phase shift blocks 11 may cover at least a part of an aperture area of the antenna array 50. In other words, the plurality of phase shift blocks 11 do not completely cover the aperture area of the antenna array 50.

According to the air interface phase shifter 10 shown in the embodiment in FIG. 10, an antenna beam can dynamically change, costs are low, and an economic effect is better.

It may be understood that, in some other possible implementations, the plurality of phase shift blocks 11 may alternatively cover an entire aperture area of the antenna array 50.

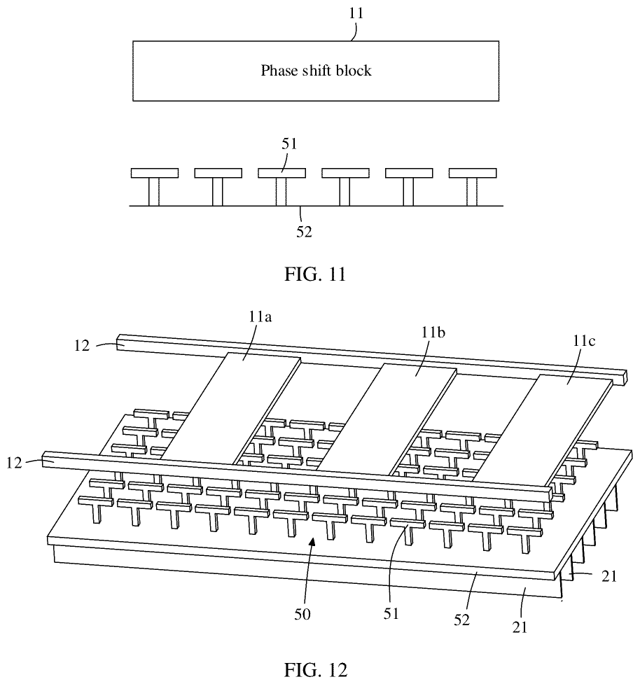

FIG. 11 is a diagram of a structure of an air interface phase shifter 10 according to another embodiment of this application.

A difference from the air interface phase shifter 10 shown in the embodiment in FIG. 10 lies in that, as shown in FIG. 11, in this embodiment, a plurality of phase shift blocks 11 of the air interface phase shifter 10 may cover an entire aperture area of an antenna array 50. In other words, the aperture area and a size of the antenna array 50 that are covered by the air interface phase shifter 10 shown in the embodiment in FIG. 10 are different from an aperture area and a size of the antenna array 50 that are covered by the air interface phase shifter 10 shown in the embodiment in FIG. 11. The air interface phase shifter 10 shown in the embodiment in FIG. 11 covers the entire aperture area of the antenna array 50. The air interface phase shifter 10 shown in the embodiment in FIG. 10 covers a part of the aperture area of the antenna array.

In comparison with the air interface phase shifter 10 shown in the embodiment in FIG. 10, beam adjustment and control with better effects can be implemented based on the air interface phase shifter 10 shown in the embodiment in FIG. 11.

FIG. 12 is a diagram of a structure of an air interface phase shifter 10 according to another embodiment of this application.

In this embodiment, the air interface phase shifter 10 may include a plurality of phase shift blocks 11, the plurality of phase shift blocks 11 are disposed above an antenna array 50, and the plurality of phase shift blocks 11 may be located on a same horizontal plane, that is, the plurality of phase shift blocks 11 are of a single-layer structure. In FIG. 10, three phase shift blocks 11 are only used as an example for description. The air interface phase shifter 10 may include three phase shift blocks 11a, 11b, and 11c.

It may be understood that, in this embodiment, the three phase shift blocks 11a, 11b, and 11c may all slide along a pair of slide rails. As shown in FIG. 12, the phase shift blocks 11a, 11b, and 11c may slide along guide rails 12 on two sides. The phase shift blocks 11a, 11b, and 11c may slide in a vertical or horizontal direction of an antenna, so that more beam direction changes of the antenna are implemented.

In an optional implementation, the two guide rails 12 may be fastened to two sides of a housing of an antenna apparatus. Alternatively, a fastening support may be disposed, and the two guide rails are fitted with the fastening support. In this way, the phase shift blocks 11 can be stably moved on the two slide rails.

A feeding network phase shifter 20 may include a plurality of phase shift blocks 21 disposed in parallel, and the antenna array 50 may include a reflection panel 52 and a plurality of radiating elements 51 arranged in an array. The feeding network phase shifter 20 is disposed on a lower surface of the reflection panel 52, and the plurality of radiating elements 51 may be disposed on an upper surface of the reflection panel 52. The reflection panel 52 may be a metal reflection panel made of a metal material.

FIG. 12 shows six phase shift blocks 21 and six columns of radiating elements 51 as an example for description. One phase shift block 21 may correspond to one column of radiating elements 51. It may be understood that each phase shift block 21 may correspondingly adjust beam directions of one column of radiating elements 51.

It may be understood that the phase shift block 21 in this embodiment is plate-shaped, in other words, the phase shift block 21 may be a phase shift plate.

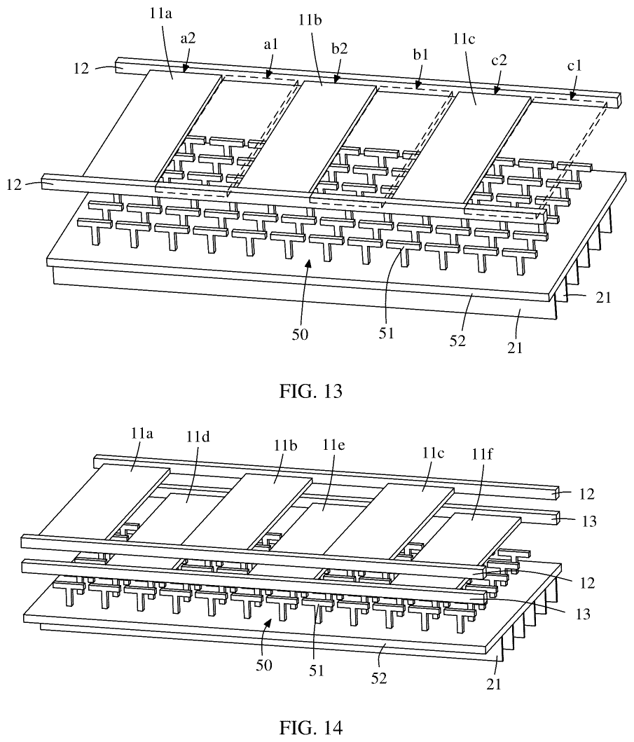

For example, as shown in FIG. 13, under control of a drive mechanism 80, a motor 92 may control, via a pull rod, the phase shift blocks 11a, 11b, and 11c to slide along the guide rails 12 on the two sides. Specifically, the phase shift block 11a may be moved from a position a1 (that is, an original position) to a position a2 (a position after movement). The phase shift block 11b may be moved from a position b1 (that is, an original position) to a position b2 (a position after movement). The phase shift block 11c may be moved from a position c1 (that is, an original position) to a position c2 (a position after movement).

According to embodiments shown in FIG. 12 and FIG. 13, under control of the drive mechanism, the plurality of phase shift blocks 11 may slide in the vertical or horizontal direction of the antenna, to implement a beam direction change of the antenna. In this way, the phase shift block 11 can be adjusted to a position in which radiation efficiency of the antenna is optimal.

It may be understood that the air interface phase shifter 10 in this embodiment of this application may be mechanically moved based on electrical tilt control. In this way, an electrical tilt system of an existing antenna can be shared, and no additional cost is increased.

FIG. 14 is a diagram of a structure of an air interface phase shifter 10 according to another embodiment of this application.

A difference from the air interface phase shifter 10 shown in the embodiment in FIG. 12 lies in that, as shown in FIG. 14, in this embodiment, the air interface phase shifter 10 may include a plurality of phase shift blocks 11, the plurality of phase shift blocks 11 may be disposed above an antenna array 50, and the plurality of phase shift blocks 11 may be disposed on a plurality of different horizontal planes. For example, the plurality of phase shift blocks 11 may slide along a plurality of pairs of slide rails. In other words, the plurality of phase shift blocks 11 may be of a double-layer structure or a multi-layer structure.

In FIG. 14, six phase shift blocks 11 are only used as an example for description. The air interface phase shifter 10 may include six phase shift blocks 11a, 11b, 11c, 11d, 11e, and 11f.

The phase shift blocks 11a, 11b, and 11c may be located on a same horizontal plane, in other words, the phase shift blocks 11a, 11b, and 11c may be at a same layer, and the phase shift blocks 11d, 11e, and 11f may be located on a same horizontal plane, in other words, the phase shift blocks 11d, 11e, and 11f may be at another layer.

As shown in FIG. 14, the phase shift blocks 11a, 11b, and 11c are phase shift blocks at an upper layer, and the phase shift blocks 11d, 11e, and 11f are phase shift blocks at a lower layer. The phase shift blocks 11a, 11b, and 11c may be moved on a same first horizontal plane. The phase shift blocks 11d, 11e, and 11f may be moved on a same second horizontal plane, and the first horizontal plane is located above the second horizontal plane.

It may be understood that, in this embodiment, under control of a drive mechanism 80, for example, a motor 92 may control, via a pull rod, the phase shift blocks 11a, 11b, and 11c to slide along guide rails 12 on two sides, to control a relative position between the phase shift blocks 11a, 11b, and 11c to be changed. The motor 92 may further control, via a pull rod, the phase shift blocks 11d, 11e, and 11f to slide along guide rails 13 on the two sides, to control a relative position between the phase shift blocks 11d, 11e, and 11f to be changed.

The phase shift blocks 11a, 11b, 11c, 11d, 11e, and 11f may slide in a vertical or horizontal direction of an antenna to obtain more physical states. In this way, more beam direction states of the antenna can be implemented.

Compared with the embodiment shown in FIG. 12, the embodiment shown in FIG. 14 has technical effects such as more freedom and richer beam expansion.

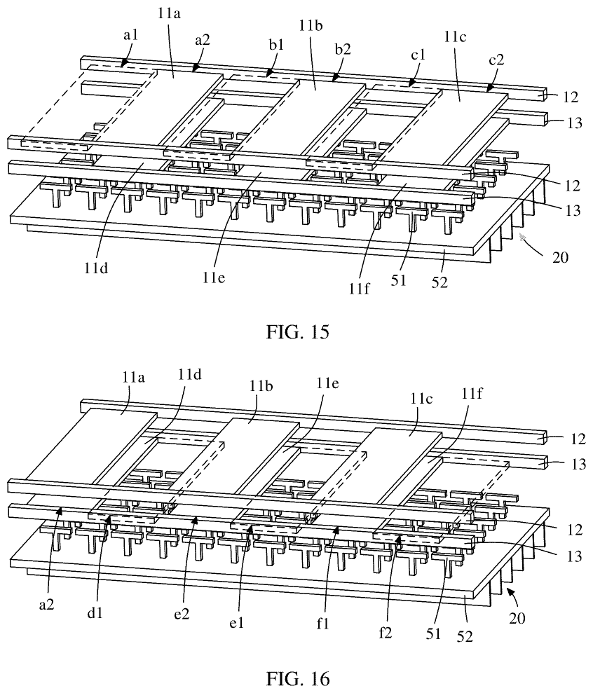

As shown in FIG. 15, in a possible scenario, the drive mechanism may control the phase shift blocks 11a, 11b, and 11c at the upper layer to slide, and the phase shift blocks 11d, 11e, and 11f at the lower layer not to slide. For example, the phase shift block 11a may be moved from a position a1 (that is, an original position) to a position a2 (a position after movement). The phase shift block 11b may be moved from a position b1 (that is, an original position) to a position b2 (a position after movement). The phase shift block 11c may be moved from a position c1 (that is, an original position) to a position c2 (a position after movement).

As shown in FIG. 16, in another possible scenario, the drive mechanism may control the phase shift blocks 11a, 11b, and 11c at the upper layer not to slide, and the phase shift blocks 11d, 11e, and 11f at the lower layer to slide. For example, the phase shift block 11d may be moved from a position d1 (that is, an original position) to a position d2 (a position after movement). The phase shift block 11e may be moved from a position e1 (that is, an original position) to a position e2 (a position after movement). The phase shift block 11f may be moved from a position f1 (that is, an original position) to a position f2 (a position after movement).

According to embodiments shown in FIG. 14 to FIG. 16, under control of the drive mechanism, the motor may control, via the pull rod, a relative position between the plurality of phase shift blocks in the air interface phase shifter 10 to be changed, to implement beam adjustment and control.

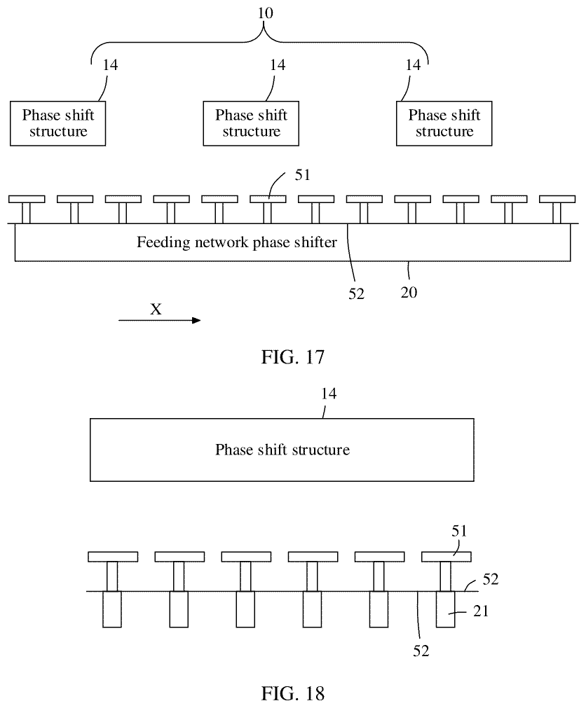

FIG. 17 is a diagram of a structure of an air interface phase shifter 10 according to another embodiment of this application. It may be understood that, in this embodiment, the air interface phase shifter 10 may include a plurality of phase shift structures 14.

As shown in FIG. 17, the plurality of phase shift structures 14 may be disposed above an antenna array 50. The plurality of phase shift structures 14 may cover a plurality of radiating elements 51 in a first direction. The first direction may be an X direction shown in FIG. 17. In other words, the plurality of phase shift structures 14 may be periodically distributed in longitudinal space in which an antenna beam needs to be deflected.

In this embodiment, as shown in FIG. 17, the plurality of phase shift structures 14 may cover at least a part of aperture areas of the plurality of radiating elements 51. In other words, the plurality of phase shift structures 14 do not completely cover the aperture areas of the plurality of radiating elements 51. It may be understood that, in some optional implementations, the phase shift structures of the air interface phase shifter 10 may alternatively cover all aperture areas of the plurality of radiating elements 51.

According to the air interface phase shifter 10 shown in the embodiment in FIG. 17, in this design, the antenna beam can dynamically change, and costs are low.

FIG. 18 is a diagram of a structure of an air interface phase shifter 10 according to another embodiment of this application.

A difference from the air interface phase shifter 10 shown in the embodiment in FIG. 17 lies in that, as shown in FIG. 18, in this embodiment, a phase shift structure 14 of the air interface phase shifter 10 may cover all aperture areas of a plurality of radiating elements 51. In other words, the aperture area and a size of the antenna array 50 that are covered by the air interface phase shifter 10 shown in the embodiment in FIG. 17 are different from an aperture area and a size of the antenna array 50 that are covered by the air interface phase shifter 10 shown in the embodiment in FIG. 18. The air interface phase shifter 10 shown in the embodiment in FIG. 18 covers the entire aperture area of the antenna array 50. The air interface phase shifter 10 shown in the embodiment in FIG. 17 covers a part of the aperture area of the antenna array 50.

In comparison with the air interface phase shifter 10 shown in the embodiment in FIG. 17, beam adjustment and control with better effects can be implemented based on the air interface phase shifter 10 shown in the embodiment in FIG. 18.

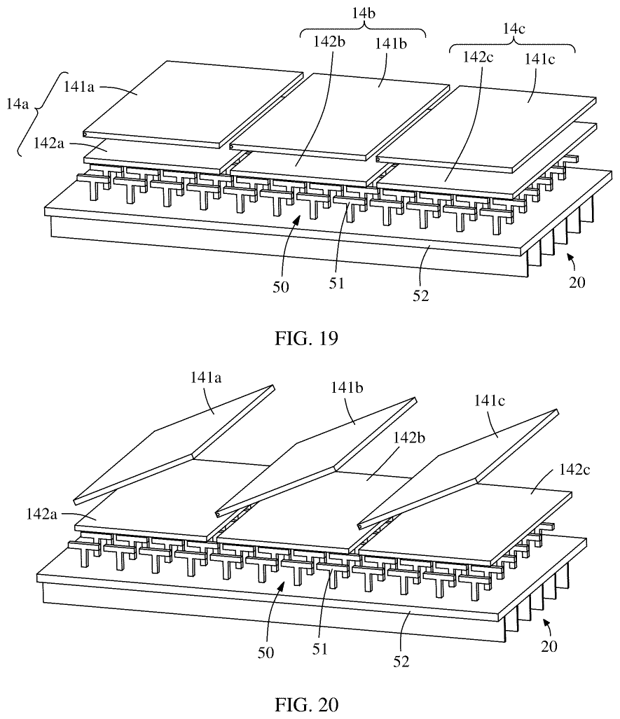

FIG. 19 is a diagram of an air interface phase shifter 10 according to another embodiment of this application.

In this embodiment, the air interface phase shifter 10 may include a plurality of phase shift structures 14. FIG. 19 shows only three phase shift structures 14 as an example for description. For example, the air interface phase shifter 10 may include phase shift structures 14a, 14b, and 14c. The phase shift structures 14a, 14b, and 14c may be disposed above an antenna array 50.

The phase shift structure 14a may include phase shift blocks 141a and 142a, the phase shift structure 14b may include phase shift blocks 141b and 142b, and the phase shift structure 14c may include phase shift blocks 141c and 142ac.

The phase shift blocks 141a and 142a are parallel to each other, and may be located above the antenna array 50. The phase shift blocks 141b and 142b are parallel to each other, and may be located above the antenna array 50. The phase shift blocks 141c and 142c are parallel to each other, and may be located above the antenna array 50.

A feeding network phase shifter 20 may include a plurality of phase shift blocks 21 disposed in parallel, and the antenna array 50 may include a plurality of radiating elements 51 arranged in an array. The feeding network phase shifter 20 is disposed on a lower surface of a reflection panel 52, and the antenna array 50 is disposed on an upper surface of the reflection panel 52.

In a scenario, a spacing between the phase shift block 141a and the phase shift block 142a is a first distance, a spacing between the phase shift block 141b and the phase shift block 142b is a second distance, and a spacing between the phase shift block 141c and the phase shift block 142c is a third distance. It may be understood that the first distance is equal to the second distance and the third distance. In other words, the distance between the phase shift block 141a and the phase shifter 142a is equal to the distance between the phase shift block 141b and the phase shifter 142b or the distance between the phase shift block 141c and the phase shifter 142c.

It may be understood that a drive mechanism 80 may control movement of the plurality of phase shift structures 14 in the air interface phase shifter 10. Specifically, the drive mechanism 80 may be configured to control the spacing between the phase shift block 141a and the phase shift block 142a. The drive mechanism 80 may be configured to control the spacing between the phase shift block 141b and the phase shift block 142b. The drive mechanism 80 may be configured to control the spacing between the phase shift block 141c and the phase shift block 142c.

FIG. 20 is a diagram of an air interface phase shifter 10 according to another embodiment of this application.

A difference from the air interface phase shifter 10 shown in the embodiment in FIG. 19 lies in that, as shown in FIG. 20, in this embodiment, one layer in a structure rotates by using a cross section as an axis, so that the phase shift structure has a height change in a vertical direction of an antenna. In this way, more vertical beam direction changes of the antenna are implemented.

For example, as shown in FIG. 20, rotation is performed by using a cross section of a phase shift block 141a as an axis, so that a height between the phase shift block 141a and a phase shift block 142a changes linearly. Rotation is performed by using a cross section of a phase shift block 141b as an axis, so that a height between the phase shift block 141b and a phase shift block 142b changes linearly. Rotation is performed by using a cross section of a phase shift block 141c as an axis, so that a height between the phase shift block 141c and a phase shift block 142c changes linearly.

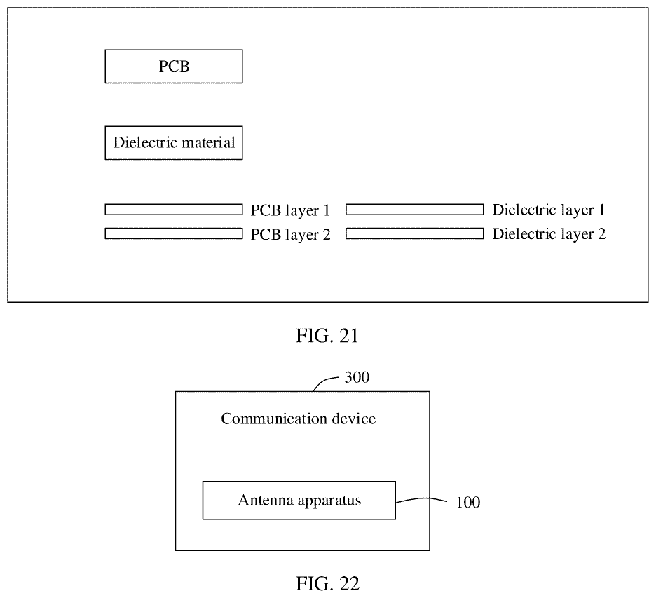

It should be noted that the phase shift block mentioned in the foregoing embodiments may be implemented by using a metal periodic structure printed on a printed circuit board (PCB) board. In some other possible implementations, the phase shift block may alternatively be a dielectric material. It may be understood that, the dielectric material may be a material with one dielectric constant, or may be a dielectric material with a specific structure, or may be a dielectric material with non-uniformly distributed dielectric constants. For example, as shown in FIG. 21, in an implementation, a phase shift block may include a dielectric layer 1 and a dielectric layer 2. In another implementation, a phase shift block includes a PCB layer 1 and a PCB layer 2. In other words, the phase shift block in embodiments of this application may be made of a dielectric material, or may be designed based on a periodic metal structure of a PCB process, to implement needed phase penetration. In comparison with a feeding network, this application has advantages such as low costs and a lightweight.

FIG. 22 is a diagram of a structure of a communication device 300 according to an embodiment of this application.

It may be understood that the communication device 300 may include a housing and the antenna apparatus 100 described in the foregoing embodiments. The antenna apparatus 100 may be disposed in the housing.

It may be understood that, in some possible application scenarios, the communication device 300 may be a base station.

In embodiments of this application, an electronic tuning function of digital phase shifter may be added to an array without a feeding network phase shifter (for example, a MIMO antenna), to implement more beam states. In embodiments of this application, in an array in which a phase shift feeding network already exists (for example, a passive antenna), an array sweeping range can be further expanded, and signal coverage can be improved.

A person of ordinary skill in the art should understand that the foregoing implementations are only intended to describe this application but are not intended to limit this application, provided that proper modifications and changes made to the foregoing implementations in the essential scope of this application fall within the protection scope of this application.

1. An antenna apparatus, comprising an antenna array, a first drive mechanism, and a first phase shifter, wherein
the antenna array comprises a plurality of radiating elements arranged in an array, and the plurality of radiating elements are configured to radiate and receive an electromagnetic wave signal;
the first drive mechanism is connected to the first phase shifter, and the first drive mechanism is configured to control movement of the first phase shifter; and
the first phase shifter is disposed above the antenna array, and the first phase shifter is configured to: when an electromagnetic wave radiated by the antenna array passes through the first phase shifter, control a phase of the electromagnetic wave radiated by the antenna array, so that a beam of the antenna array is deflected.

2. The antenna apparatus according to claim 1, wherein
the antenna apparatus further comprises a first radome; and
both the first phase shifter and the antenna array are disposed in the first radome; or the antenna array is disposed in the first radome, and the first phase shifter is disposed in a second radome of another antenna apparatus.

3. The antenna apparatus according to claim 1, wherein
the first phase shifter comprises a plurality of phase shift blocks, and the plurality of phase shift blocks are configured to cover a part of an aperture area of the antenna array.

4. The antenna apparatus according to claim 1, wherein
the first phase shifter comprises a plurality of phase shift blocks, and the plurality of phase shift blocks are configured to cover an entire aperture area of the antenna array.

5. The antenna apparatus according to claim 1, wherein
the antenna apparatus further comprises a first guide rail, the first phase shifter comprises a plurality of first phase shift blocks located above the antenna array, the plurality of first phase shift blocks are all located on a first horizontal plane, and the first drive mechanism is configured to control the plurality of first phase shift blocks to slide on the first guide rail.

6. The antenna apparatus according to claim 5, wherein
the antenna apparatus further comprises a second guide rail, the first phase shifter further comprises a plurality of second phase shift blocks located above the antenna array, the plurality of second phase shift blocks are all located on a second horizontal plane, and the first drive mechanism is configured to control the plurality of second phase shift blocks to slide on the second guide rail.

7. The antenna apparatus according to claim 1, wherein
the first phase shifter comprises a plurality of phase shift structures, each phase shift structure comprises a first phase shift block and a second phase shift block that are located above the antenna array, and the first drive mechanism is configured to control a spacing between the first phase shift block and the second phase shift block.

8. The antenna apparatus according to claim 1, wherein
the antenna apparatus further comprises a second phase shifter, the second phase shifter is connected to the radiating element, and the second phase shifter is configured to adjust a feeding phase of the radiating element.

9. The antenna apparatus according to claim 8, wherein
the antenna apparatus further comprises a second drive mechanism, and the second drive mechanism is configured to control movement of the second phase shifter.

10. The antenna apparatus according to claim 8, wherein
the antenna array further comprises a reflection panel, the antenna array is disposed on an upper surface of the reflection panel, and the second phase shifter is disposed on a lower surface of the reflection panel.

11. A communication device, wherein the communication device comprises an antenna apparatus, the antenna apparatus comprise an antenna array, a first drive mechanism, and a first phase shifter, wherein
the antenna array comprises a plurality of radiating elements arranged in an array, and the plurality of radiating elements are configured to radiate and receive an electromagnetic wave signal;
the first drive mechanism is connected to the first phase shifter, and the first drive mechanism is configured to control movement of the first phase shifter; and
the first phase shifter is disposed above the antenna array, and the first phase shifter is configured to: when an electromagnetic wave radiated by the antenna array passes through the first phase shifter, control a phase of the electromagnetic wave radiated by the antenna array, so that a beam of the antenna array is deflected.

12. The communication device according to claim 11, wherein the antenna apparatus further comprises a first radome; and
both the first phase shifter and the antenna array are disposed in the first radome; or the antenna array is disposed in the first radome, and the first phase shifter is disposed in a second radome of another antenna apparatus.

13. The communication device according to claim 11, wherein the first phase shifter comprises a plurality of phase shift blocks, and the plurality of phase shift blocks are configured to cover a part of an aperture area of the antenna array.

14. The communication device according to claim 11, wherein the first phase shifter comprises a plurality of phase shift blocks, and the plurality of phase shift blocks are configured to cover an entire aperture area of the antenna array.

15. The communication device according to claim 11, wherein the antenna apparatus further comprises a first guide rail, the first phase shifter comprises a plurality of first phase shift blocks located above the antenna array, the plurality of first phase shift blocks are all located on a first horizontal plane, and the first drive mechanism is configured to control the plurality of first phase shift blocks to slide on the first guide rail.

16. The communication device according to claim 15, wherein the antenna apparatus further comprises a second guide rail, the first phase shifter further comprises a plurality of second phase shift blocks located above the antenna array, the plurality of second phase shift blocks are all located on a second horizontal plane, and the first drive mechanism is configured to control the plurality of second phase shift blocks to slide on the second guide rail.

17. The communication device according to claim 11, wherein the first phase shifter comprises a plurality of phase shift structures, each phase shift structure comprises a first phase shift block and a second phase shift block that are located above the antenna array, and the first drive mechanism is configured to control a spacing between the first phase shift block and the second phase shift block.

18. The communication device according to claim 11, wherein the antenna apparatus further comprises a second phase shifter, the second phase shifter is connected to the radiating element, and the second phase shifter is configured to adjust a feeding phase of the radiating element.

19. The communication device according to claim 18, wherein the antenna apparatus further comprises a second drive mechanism, and the second drive mechanism is configured to control movement of the second phase shifter.

20. The communication device according to claim 18, wherein the antenna array further comprises a reflection panel, the antenna array is disposed on an upper surface of the reflection panel, and the second phase shifter is disposed on a lower surface of the reflection panel.
